(19) United States
(12) Patent Application Publication
(10) Pub. No.: US 2020/0356253 A1
(43) Pub. Date: Nov. 12, 2020

(54) INFORMATION PROCESSING APPARATUS AND METHOD FOR CONTROLLING INFORMATION PROCESSING APPARATUS

(71) Applicant: KYOCERA Document Solutions Inc., Osaka (JP)

(72) Inventor: Yusuke YOSHIMOTO, Osaka (JP)

(73) Assignee: KYOCERA Document Solutions Inc., Osaka (JP)

(21) Appl. No.: 16/868,228

(22) Filed: May 6, 2020

(30) Foreign Application Priority Data
May 10, 2019 (JP) 2019-090152

(51) Int. Cl. G06F 3/0488; H04N 1/00

(52) U.S. Cl. CPC G06F 3/04883; H04N 1/0045; H04N 1/00464; H04N 1/00432

(57) ABSTRACT

A controller of an information processing apparatus divides a display region of a display into a main work region and a sub-work region. The controller determines whether a window to be newly displayed is to be arranged in the main work region or in the sub-work region. When the window is to be arranged in the main work region, the controller controls the window to be displayed within the main work region so that the window does not overlap with any other window. When the window is to be arranged in the sub-work region, the controller controls the window to be displayed within the sub-work region so that the window does not overlap with any other window.

### INCORPORATION BY REFERENCE

This application is based upon and claims the benefit of priority from the corresponding Japanese Patent Application No. 2019-090152 (filed on May 10, 2019), the contents of which are incorporated herein by reference.

### BACKGROUND

The present disclosure relates to an information processing apparatus that displays a plurality of windows.

A plurality of images may be displayed within a display. In a case of displaying a plurality of images, a display screen may be divided into a plurality of regions. There is known an image information processing apparatus described below, which displays contents of each page in each of the plurality of regions resulting from the division.

Specifically, there has been described the image information processing apparatus configured as below. That is, input image data of each page is stored in an image memory. The display screen is divided into four regions, and an image of each page is displayed sequentially in each of the regions. Once such images are displayed in all the regions, page turning display is performed in which the images are each updated to an image of a succeeding page in the order of the regions in which they are displayed. The apparatus includes a display fixing memory, and a fixing region in which fixed display is performed is designated. Page data is stored in the display fixing memory so that fixed display thereof is performed. Page turning in the fixing region is suspended, while in the remaining regions other than the fixing region, page turning is resumed. This is intended to allow page turning while performing fixed display of a desired page.

There is a type of computer that displays a window. The window is allocated to a display region unique to a task. For example, a window of an application activated is displayed on a display. Furthermore, a window for browsing or editing a file opened is displayed on the display. The window can also be closed. For example, the window can be closed by clicking a “×” mark included in the window. Closing the window means finishing operating the file or the application. For example, computers such as a personal computer include displays of a size increased compared with that in the past and improved also in resolution. A plurality of windows may be displayed on such a display.

### SUMMARY

An information processing apparatus according to the present disclosure includes a display, an input device, and a controller. The input device accepts an operation. The controller controls display on the display. The controller divides a display region of the display into a main work region and a sub-work region. The controller determines whether a window to be newly displayed is to be arranged in the main work region or in the sub-work region. When the window is determined to be arranged in the main work region, the controller controls the window to be displayed as a main work window within the main work region so that the window does not overlap with any other window. When the window is determined to be arranged in the sub-work region, the controller controls the window to be displayed as a sub-work window within the sub-work region so that the window does not overlap with any other window.

A method for controlling an information processing apparatus according to the present disclosure includes steps of dividing a display region of a display of the information processing apparatus into a main work region and a sub-work region, determining whether a window to be newly displayed is to be arranged in the main work region or in the sub-work region, displaying the window, when the window is determined to be arranged in the main work region, as a main work window within the main work region so that the window does not overlap with any other window, and displaying the window, when the window is determined to be arranged in the sub-work region, as a sub-work window within the sub-work region so that the window does not overlap with any other window.

Further features and advantages of the present disclosure will be made more apparent by the following description of an embodiment.

### BRIEF DESCRIPTION OF THE DRAWINGS

FIG. 1 is a view showing an example of an information processing apparatus according to an embodiment.

FIG. 2 is a view showing an example of determination criterion data of the information processing apparatus according to the embodiment.

FIG. 3 is a view showing an example of priority determination criterion data of the information processing apparatus according to the embodiment.

FIG. 4 is a view showing an example of display of a window in the information processing apparatus according to the embodiment.

FIG. 5 is a view showing an example of display of a window in the information processing apparatus according to the embodiment.

FIG. 6 is a view showing an example of display of a window in the information processing apparatus according to the embodiment.

FIG. 7 is a view showing an example of display of a window in the information processing apparatus according to the embodiment.

FIG. 8 is a view showing an example of a process according to the embodiment, which is performed when a main work window is closed.

FIG. 9 is a view showing an example of switching between windows according to the embodiment.

FIG. 10 is a view showing an example of synchronous scrolling according to the embodiment.

### DETAILED DESCRIPTION

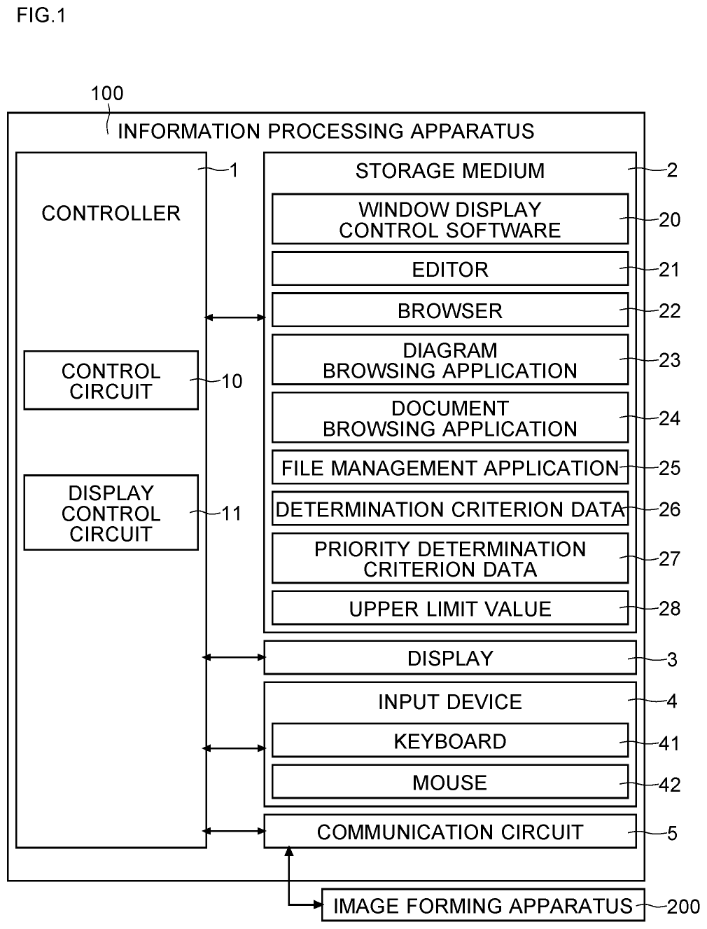

With reference to FIG. 1 to FIG. 10, the following describes an example of an information processing apparatus 100 according to an embodiment of the present disclosure. Various elements such as configurations and arrangements included in the description of this embodiment are not intended to limit the scope of the disclosure but are merely illustrative examples.

### Information Processing Apparatus 100

With reference to FIG. 1, a description is given of an example of the information processing apparatus 100 according to the embodiment. The information processing apparatus 100 is a computer. The information processing apparatus 100 is, for example, a personal computer. The information processing apparatus 100 may be any other type of computer than a personal computer. The information processing apparatus 100 includes a controller 1, a storage medium 2, a display 3, an input device 4, and a communication circuit 5. The information processing apparatus 100 is communicably connected to an image forming apparatus 200. The image forming apparatus 200 is, for example, a printer.

The controller 1 includes a control circuit 10 and a display control circuit 11. The controller 1 is a control board including a plurality of circuits and components. For example, the control circuit 10 is a CPU. The display control circuit 11 generates display image data used for performing display on the display 3. For example, the display control circuit 11 is a chip that performs an image-related process.

The information processing apparatus 100 includes, as the storage medium 2, a ROM, a storage, and a RAM. The storage is, for example, an HDD (may be an SSD). The storage medium 2 stores an OS, data, and various types of applications (application software) in a non-volatile manner. For example, such an application is installed on the storage. Based on the OS, data, and various types of applications, the controller 1 controls operations of the information processing apparatus 100. In accordance with contents stored in the storage medium 2, the controller 1 controls various portions of the information processing apparatus 100.

The controller 1 controls a screen and information to be displayed on the display 3. For example, the display 3 includes a liquid crystal display panel or an organic EL display panel. The input device 4 accepts an operation performed by a user. The input device 4 is, for example, a keyboard 41 and a mouse 42. Devices (for example, a touch panel) other than the keyboard 41 and the mouse 42 may be used as the input device 4. Based on an output of the input device 4, the controller 1 recognizes contents of an operation performed. The input device 4 accepts a setting operation with respect to the information processing apparatus 100 performed by a user.

Specifically, the input device 4 accepts an operation of opening a widow. The operation of opening a window is, for example, an operation of opening a file. For example, an operation of double-clicking an icon representing a file is the operation of opening the file. Furthermore, the operation of opening a window may be an operation of selecting an application to be used and activating the application. For example, an operation of double-clicking an icon representing an application is the operation of activating the application.

The communication circuit 5 includes a communication control circuit and a communication memory. The communication memory stores communication software. The communication circuit 5 communicates with a computer on a network or the image forming apparatus 200. For example, the communication circuit 5 can download data from a server on the Internet.

### Application

Next, with reference to FIG. 1, a description is given of an example of an application stored by the information processing apparatus 100 according to the embodiment. Examples of applications installed on the storage medium 2 (the storage) of the information processing apparatus 100 are listed below. Applications installed on the storage medium 2, however, are not limited to the examples listed below.

### Editor 21

An application for inputting characters and symbols so as to perform editing

### Browser 22

An application for browsing a web page

### Diagram Browsing Application 23

An application for browsing diagrammatic material (a drawing file)

### Document Browsing Application 24

An application for browsing document material (a document file)

### File Management Application 25

An application used to select, move, search for, or delete a file or a folder

For example, in a case of performing coding of software (an application), the editor 21 is activated. The controller 1 controls a window of the editor 21 to be displayed on the display 3. A user uses the input device 4 (the keyboard 41) and the editor 21 to write a source code. The controller 1 controls the code thus written to be displayed within the window of the editor 21.

Furthermore, when it is wished to refer to information on a network, the browser 22 is activated. The input device 4 accepts an input of a search word for searching for a web page to be referred to. The controller 1 controls a window of the browser 22 to be displayed on the display 3. The controller 1 controls the communication circuit 5 to acquire page contents (data) from a web page selected by the input device 4. Based on the data thus acquired, the controller 1 controls the page contents to be displayed within the window of the browser 22.

Furthermore, when it is wished to work while browsing or referring to a diagram, the diagram browsing application 23 is activated. The input device 4 accepts designation of a file to be browsed. The controller 1 controls contents of the file thus designated to be displayed within a window of the diagram browsing application 23.

Furthermore, when it is wished to work while browsing or referring to a document such as a specification, the document browsing application 24 is activated. The input device 4 accepts designation of a document file to be browsed. The controller 1 controls contents of the document file thus designated to be displayed within a window of the document browsing application 24.

### Process for Newly Displaying Window

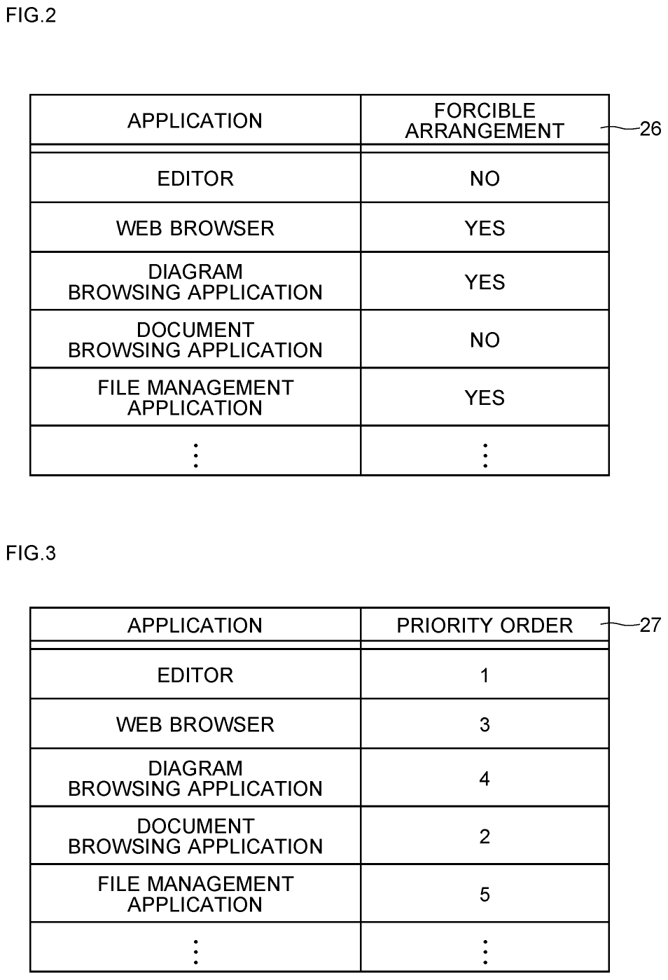

Next, with reference to FIG. 2 to FIG. 7, a description is given of an example of display of a window in the information processing apparatus 100 according to the embodiment. Window display control software 20 is installed on the storage medium 2 (the storage) of the information processing apparatus 100. The window display control software 20 is software for controlling display of a window on the display 3. Based on the window display control software 20, the controller 1 controls display of a window on the display 3. Based on the window display control software 20, the controller 1 controls one or more windows to be displayed within the screen of the display 3.

Upon activation of an application or opening of a file, based on the window display control software 20, the controller 1 controls a window to be newly displayed on the display 3. The controller 1 determines whether the window to be newly displayed is to be arranged in a main work region F1 or in a sub-work region F2. In the following description, a window arranged (displayed) in the main work region F1 by the controller 1 is referred to as a main work window 6. Furthermore, a window arranged (displayed) in the sub-work region F2 by the controller 1 is referred to as a sub-work window 7.

The storage medium 2 stores determination criterion data 26 in a non-volatile manner (see FIG. 1). The determination criterion data 26 is data defining, among applications of windows to be newly displayed, an application to be arranged in the sub-work region F2. In other words, the determination criterion data 26 is data defining an application whose window is to be forcibly arranged in the sub-work region F2. FIG. 2 shows an example of the determination criterion data 26. The determination criterion data 26 is table data defining whether or not to arrange each application installed on the storage medium 2 in the sub-work region F2.

For example, a user can create or edit the determination criterion data 26. For example, via a setting screen of the window display control software 20, it is possible to create or edit the determination criterion data 26. The input device 4 accepts an operation of creating or editing the determination criterion data 26. The controller 1 controls the determination criterion data 26 thus edited to be stored in the storage medium 2.

Based on an application whose window is to be newly displayed, the controller 1 refers to the determination criterion data 26 and determines whether the window is to be arranged in the main work region F1 or in the sub-work region F2. For example, when a window to be newly displayed is a window of an application defined to be arranged in the sub-work region F2, the controller 1 determines to arrange the new window in the sub-work region F2. For example, in coding an application, file handling is a temporary (secondary) operation. As shown in FIG. 2, a window of the file management application 25 may be set to be automatically arranged in the sub-work region F2.

Furthermore, even when a new window is not defined to be arranged in the sub-work region F2, upon a forcible arrangement operation being performed, the controller 1 may arrange the new window in the sub-work region F2. A type of operation used as the forcible arrangement operation is previously determined. For example, an operation of activating an application while pressing a Ctrl key of the keyboard 41 or an operation of opening a file while pressing the Ctrl key can be used as the forcible arrangement operation.

The controller 1 divides a display region of the display 3 into the main work region F1 and the sub-work region F2. For example, the main work region F1 is a region in which a window of an application principally used (used for work) by a user. For example, in a case of coding, it is conceived that the window of the editor 21 is arranged in the main work region F1. Furthermore, in a case of performing document creation, it is conceived that the window of the document browsing application 24 is arranged in the main work region F1.

For example, the sub-work region F2 is a region in which a window displaying information referred to during work. For example, in the case of coding, it is conceived that the window of the browser 22 or the window of the diagram browsing application 23 is arranged in the sub-work region F2.

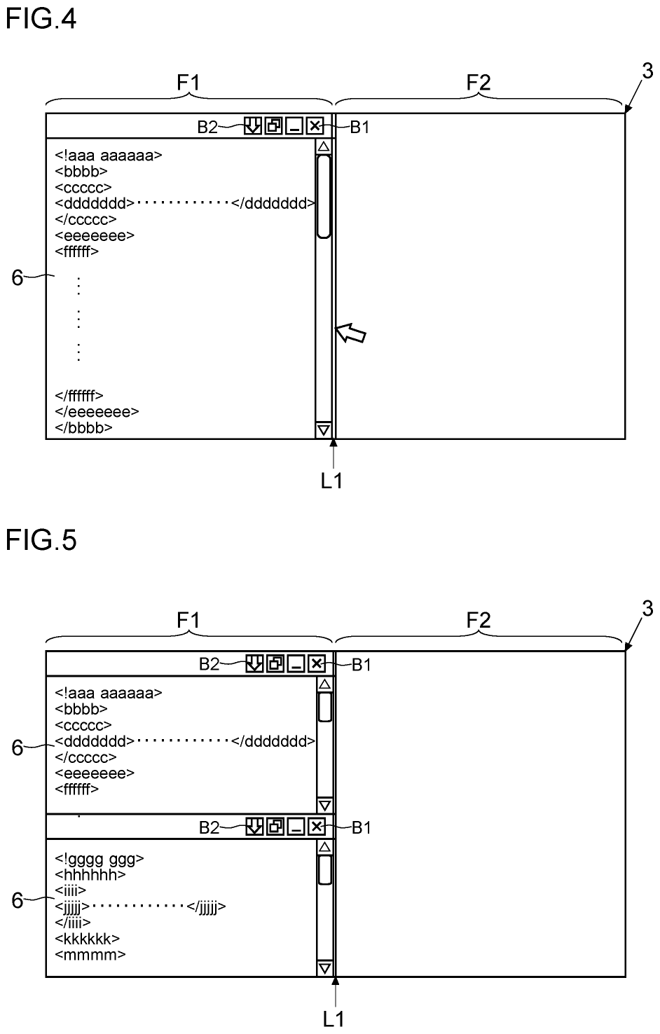

FIG. 4 and the subsequent figures show an example in which a left half area of the display region of the display 3 is set as the main work region F1, and a right half area thereof is set as the sub-work region F2. A configuration may be adopted in which a right half of the display region of the display 3 is set as the main work region F1, and a left half thereof is set as the sub-work region F2. In FIG. 4 and the subsequent figures, a double line (a thick line) in a longitudinal direction represents a boundary line L1 between the main work region F1 and the sub-work region F2. A specific color (for example, red) may be used as a color of the boundary line L1.

Here, the input device 4 accepts a setting of respective positions and sizes of the main work region F1 and the sub-work region F2 within the display region. For example, the boundary line L1 between the main work region F1 and the sub-work region F2 is dragged with the mouse 42, and thus the respective sizes and positions (locations) of the main work region F1 and the sub-work region F2 can be changed. In FIG. 4 and the subsequent figures, when the boundary line L1 is moved to the left, the main work region F1 becomes narrower and the sub-work region F2 becomes wider. Conversely, when the boundary line L1 is moved to the right, the main work region F1 becomes wider and the sub-work region F2 becomes narrower. Furthermore, a configuration may be adopted in which the respective sizes and positions of the main work region F1 and the sub-work region F2 can be set using numerical values. In this case, the controller 1 controls the main work region F1 and the sub-work region F2 to be displayed on the display 3 so that their respective positions and sizes are as set by the input device 4.

FIG. 4 to FIG. 7 show an example in which the window of the editor 21 that edits codes of an application is arranged in the main work region F1. As shown in FIG. 4, the controller 1 may limit the number of main work windows 6 to one. Furthermore, as shown in FIG. 5, the controller 1 may arrange a plurality of main work windows 6 in the main work region F1.

An upper limit value 28 of the number of main work windows 6 arranged is previously determined. The upper limit value 28 is an integer of one or more. The storage medium 2 stores the upper limit value 28 in a non-volatile manner (see FIG. 1). The input device 4 accepts a setting of the upper limit value 28. For example, a user sets the upper limit value 28 on the setting screen of the window display control software 20. The controller 1 controls the upper limit value 28 thus set to be stored in the storage medium 2. When an application whose window is to be newly displayed is not an application that is to be forcibly arranged in the sub-work region F2, the controller 1 checks whether or not there is an unoccupied space in the main work region F1. In other words, the controller 1 checks whether or not the number of main work windows 6 arranged has reached the upper limit value 28.

When the number of main work windows 6 arranged has reached the upper limit value 28, the controller 1 determines to arrange the window to be newly displayed in the sub-work region F2. In this case, by the controller 1, the window to be newly displayed is set to be the sub-work window 7. When the number of main work windows 6 arranged has not reached the upper limit value 28, the controller 1 determines to arrange the window to be newly displayed in the main work region F1. In this case, by the controller 1, the window to be newly displayed is set to be the main work window 6.

When increasing or decreasing the number of main work windows 6, the controller 1 automatically adjusts a size and a position of each of the main work windows 6. Specifically, in a case where the number of main work windows 6 arranged is plural, the controller 1 equally divides the main work region F1 by the number of main work windows 6 arranged. FIG. 5 shows an example in which the number of main work windows 6 arranged is two, and the controller 1 divides the main work region F1 into upper and lower regions. The controller 1 arranges each of the main work windows 6 in each of these regions resulting from the division. The controller 1 sets each of the main work windows 6 to be equal in size to each of the regions resulting from the division. The controller 1 arranges the main work windows 6 so that they do not overlap with each other and so that no unoccupied region is generated.

In a case where the number of main work windows 6 arranged is one, the controller 1 sets the main work window 6 to be equal in size to the main work region F1. In accordance with an increase or a decrease in the number of main work windows 6 arranged, the controller 1 automatically adjusts a size and a position of each of the main work windows 6.

For example, when the number of main work windows 6 arranged is increased from one to two, the screen of the display 3 changes from a state shown in FIG. 4 to a state shown in FIG. 5. A window on the display 3 can be closed by operating a close button B1. The close button B1 is a button including a “×” mark at an upper right corner of each window. When the number of main work windows 6 arranged is decreased from two to one, the screen of the display 3 changes from the state shown in FIG. 5 to the state shown in FIG. 4.

Upon determining that a new window is to be arranged in the sub-work region F2, the controller 1 arranges the new window in the sub-work region F2. The controller 1 controls the new window to be displayed as the sub-work window 7. Here, in a case of arranging a plurality of windows in the sub-work region F2, the controller 1 sets priorities of the sub-work windows 7. Based on priority determination criterion data 27, the controller 1 sets priorities of the sub-work windows 7.

In a case where the number of sub-work windows 7 is only one, the controller 1 does not perform priority setting. In this case, the controller 1 controls the one sub-work window 7 to be displayed in the sub-work region F2. The controller 1 may set the sub-work window 7 to be equal in size to the sub-work region F2. In other words, when the number of sub-work windows 7 is only one, the controller 1 may control the sub-work window 7 to be displayed in a maximum size.

FIG. 3 shows an example of the priority determination criterion data 27. The priority determination criterion data 27 is table data in which priorities in the sub-work region F2 are set for applications installed on the storage medium 2. In this manner, the controller 1 may perform priority setting based on applications corresponding to the sub-work windows 7, respectively.

For example, a user can create or edit the priority determination criterion data 27. It is possible to create or edit the priority determination criterion data 27 via, for example, the setting screen of the window display control software 20. The input device 4 accepts an operation of creating or editing the priority determination criterion data 27. The controller 1 controls the priority determination criterion data 27 thus edited to be stored in the storage medium 2.

A plurality of sub-work windows 7 of the same application may be opened. In other words, based on the same application, a plurality of sub-work windows 7 may be displayed. In this case, the controller 1 may set priorities of the sub-work windows 7 of the same application so that the longer a lapse of time from the start of display is, the higher the priority is. Conversely, the controller 1 may set priorities therefor so that the shorter a lapse of time from the start of display is, the higher the priority is.

The input device 4 may accept a selection between configurations described above, i.e. a configuration in which the longer a lapse of time from the start of display is, the higher the priority is and a configuration in which the shorter a lapse of time from the start of display is, the higher the priority is. For example, a user previously makes a setting (a selection) as to this matter on the setting screen of the window display control software 20. Based on the selected one of the configurations, the controller 1 sets priorities of the sub-work windows 7 of the same application.

When the number of sub-work windows 7 arranged is two or more, the controller 1 divides the sub-work region F2. The controller 1 arranges each of the sub-work windows 7 in each of regions resulting from the division. The controller 1 sets the sub-work windows 7 to be equal in size to the regions resulting from the division.

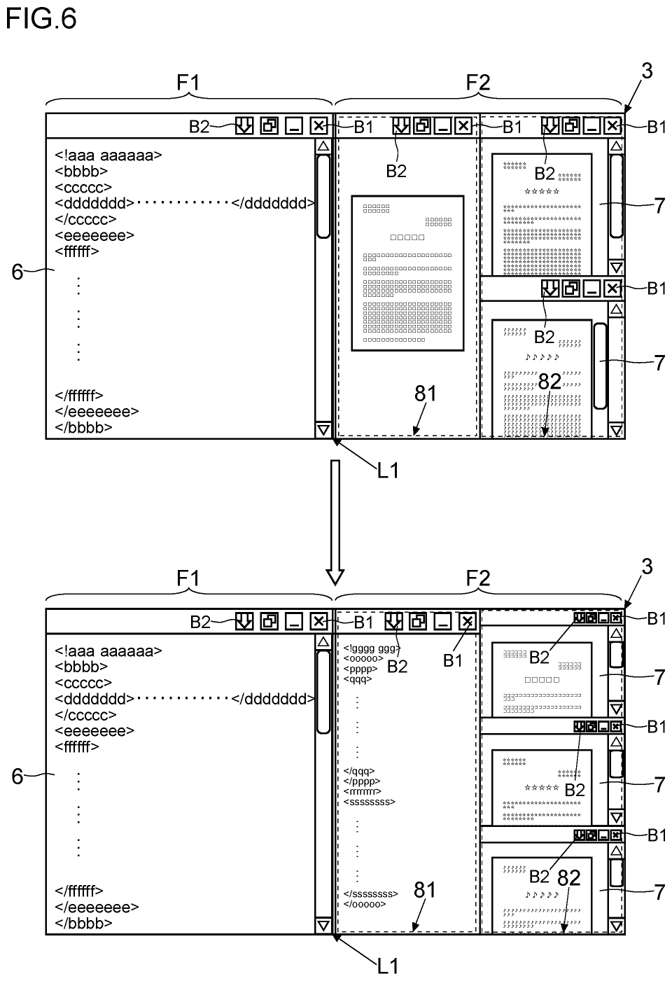

As shown in FIG. 6, the controller 1 may divide the sub-work region F2 into regions of varying sizes. In other words, the controller 1 may set the sub-work windows 7 to vary in size. FIG. 6 shows an example in which 50% of the sub-work region F2 is allocated to one of the sub-work windows 7 that has a first priority. In a case of FIG. 6, a left region in the sub-work region F2 is a first priority region 81 allocated to the one of the sub-work windows 7 that has the first priority. During a time when the number of sub-work windows 7 arranged is two or more, the controller 1 controls a size and a position of the first priority region 81 to be fixed. The controller 1 sets the first priority region 81 to be equal in size to the one of the sub-work windows 7 that has the first priority.

FIG. 6 also shows an example in which regions allocated respectively to the other sub-work windows 7 that have second or lower priorities are set to be uniform in size. The controller 1 may set each of the regions allocated respectively to these sub-work windows 7 to gradually decrease in size with decreasing priority of the sub-work windows 7. When the number of sub-work windows 7 arranged is two or more, the controller 1 divides a region (a lower priority region 82) in the sub-work region F2 other than the first priority region 81. The controller 1 uniformly divides the lower priority region 82 by a value obtained by subtracting one from the number of sub-work windows 7 arranged. Then, the controller 1 arranges each of the other sub-work windows 7 that have the second or lower priorities in each of regions resulting from dividing the lower priority region 82. For example, the controller 1 arranges the other sub-work windows 7 that have the second or lower priorities so that the higher the priority is, the higher in level an arrangement position is. The controller 1 sets each of the regions resulting from dividing the lower priority region 82 to be equal in size to each of the other sub-work windows 7 that have the second or lower priorities.

An upper view in FIG. 6 shows an example of a display screen in a case where the number of sub-work windows 7 arranged is three. A lower view in FIG. 6 shows an example of the display screen in a case where the number of sub-work windows 7 arranged is changed to four. As shown in FIG. 6, the controller 1 does not change the size and the position of the first priority region 81. When, however, the number of sub-work windows 7 is changed, the controller 1 changes the number of regions resulting from dividing the lower priority region 82 and a position and a size of each window of in the lower priority region 82.

When a window is newly arranged in the sub-work region F2 or when any of the sub-work windows 7 is closed, the sub-work windows 7 being displayed may be changed in priority. The controller 1 automatically adjusts a position and a size of each of the sub-work windows 7 in accordance with the thus changed priorities of the sub-work windows 7. For example, in a case where a sub-work window 7 to be newly displayed has a first priority, the controller 1 arranges the sub-work window 7 to be newly displayed in the first priority region 81. Furthermore, the controller 1 moves one of the sub-work windows 7 that has been in the first priority region 81 to the lower priority region 82.

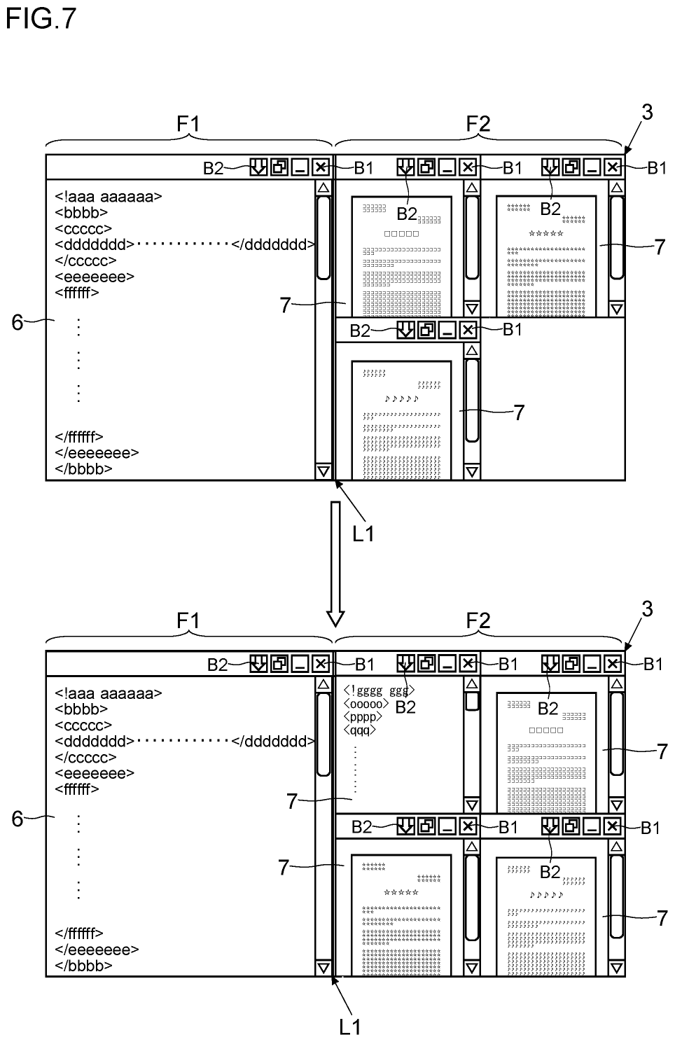

FIG. 7, on the other hand, shows an example in which the sub-work windows 7 do not vary in size with their priorities. The controller 1 may set the sub-work windows 7 to be uniform in size. In this case, division candidate values used for dividing the sub-work region F2 are set previously. For example, the division candidate values may be positive multiples of 2. For example, the division candidate values are 2, 4, 6, and 8. A maximum value of the division candidate values used for dividing the sub-work region F2 may be set previously. For example, the maximum value of the division candidate values used for dividing the sub-work region F2 may be set to 8.

In this case, based on the number of sub-work windows 7 arranged, the controller 1 selects the number of regions resulting from dividing the sub-work region F2 from among the division candidate values. The controller 1 selects a minimum division candidate value from among those of the division candidate values that are equal to or more than the number of sub-work windows 7 arranged. For example, when the number of sub-work windows 7 arranged is three, the controller 1 selects 4 from among the division candidate values (see FIG. 7).

Every time the number of sub-work windows 7 is increased or decreased, the controller 1 makes a selection from among the division candidate values. The controller 1 uniformly divides the sub-work region F2 by a newly selected one of the division candidate values. The controller 1 allocates each of the sub-work windows 7 to each of regions resulting from the division. The controller 1 sets each of the sub-work windows 7 to be equal in size to each of the regions allocated thereto. Thus, the controller 1 arranges the sub-work windows 7 in the sub-work region F2 so that the sub-work windows 7 do not overlap with each other.

In a case of uniformly dividing the sub-work region F2, an order (a rule) for arranging the sub-work windows 7 may be preset based on priorities of the sub-work windows 7. For example, the controller 1 may arrange the sub-work windows 7 in a Z-shaped order. Furthermore, the input device 4 may accept a setting of the order of arrangement. Based on the setting, the controller 1 arranges each of the sub-work windows 7 in each of regions resulting from uniformly dividing the sub-work region F2.

The input device 4 accepts a selection between a first technique and a second technique. The first technique is a technique in which the sub-work windows 7 are set to vary in size. The second technique is a technique in which all the sub-work windows 7 are set to be uniform in size. For example, a user previously sets (selects) the first technique or the second technique on the setting screen of the window display control software 20. Based on the technique thus selected, the controller 1 controls the sub-work windows 7 to be displayed.

In this manner, the controller 1 arranges the sub-work windows 7 in the sub-work region F2 so that the sub-work windows 7 do no overlap with each other. Every time the number of sub-work windows 7 arranged is changed (increased or decreased), the controller 1 starts over division and adjusts a size of each of the sub-work windows 7.

Upon determining that a window to be newly displayed is to be arranged in the sub-work region F2, the controller 1 increases the number of sub-work windows 7 displayed. The controller 1 changes the number of regions resulting from dividing the sub-work region F2 and automatically adjusts a size and a position of each of the sub-work windows 7. The controller 1 arranges all the sub-work windows 7 in the sub-work region F2 so that the sub-work windows 7 do not overlap with each other.

When any of the sub-work windows 7 is closed, the number of sub-work windows 7 arranged is decreased. Also in this case, the controller 1 changes the number of regions resulting from dividing the sub-work region F2 and automatically adjusts a size and a position of each of the sub-work windows 7. The controller 1 rearranges the sub-work windows 7 so that the sub-work windows 7 do not overlap with each other.

### Process Performed when Main Work Window 6 is Closed

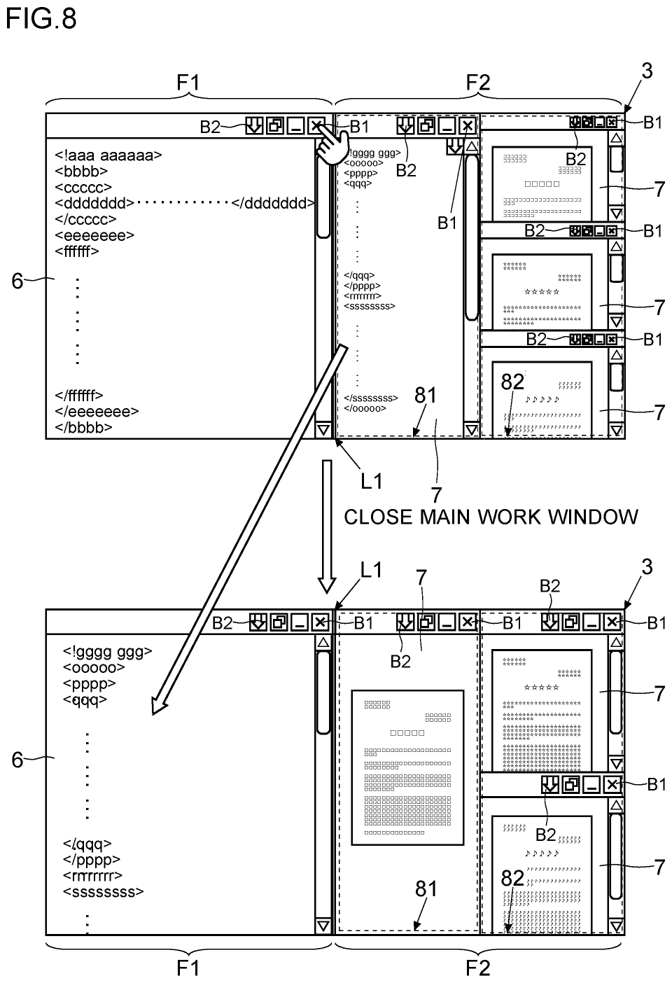

Next, with reference to FIG. 8, a description is given of an example of a process performed when the main work window 6 is closed. A user can operate the close button B1 of each window. For example, the user can click the close button B1 with the mouse 42. At this time, the controller 1 closes (dismisses display of) a window whose close button B1 has been operated. In a case where the main work window 6 is closed, when there are sub-work windows 7, the controller 1 may move any one of the sub-work windows 7 to the main work region F1. At this time, the controller 1 dismisses, from the sub-work region F2, the any one of the sub-work windows 7 that has been moved. The controller 1 prevents windows of the same contents from being displayed respectively in the main work region F1 and the sub-work region F2 in a duplicated manner.

The controller 1 may move a most recently operated one of the sub-work windows 7 to the main work region F1. Alternatively, the controller 1 may move one of the sub-work windows 7 that has a highest priority to the main work region F1.

The input device 4 may accept a setting of a criterion for selecting one of the sub-work windows 7 that is to be moved to the main work region F1. For example, the input device 4 may accept a setting to set a most recently operated one of the sub-work windows 7 to be a window to be moved. Furthermore, the input device 4 may accept a setting to set one of the sub-work windows 7 that has the first priority to be the window to be moved. In a case where there are a plurality of sub-work windows 7, based on a setting made by the input device 4, the controller 1 selects one of the sub-work windows 7 that is to be moved. In a case where there is only one sub-work window 7, the controller 1 moves the one sub-work window 7 to the main work region F1.

An upper view in FIG. 8 shows an example in which one main work window 6 is arranged in the main work region F1, and four sub-work windows 7 are arranged in the sub-work region F2. The upper view in FIG. 8 shows a state where the close button B1 of the main work window 6 is being operated.

A lower view in FIG. 8 shows an example in which in response to the main work window 6 being closed, one of the sub-work windows 7 is automatically moved to the main work region F1. As shown in the lower view in FIG. 8, when the number of sub-work windows 7 arranged is decreased as a result of any of the sub-work windows 7 being moved, the controller 1 automatically adjusts a size and a position of each of the sub-work windows 7.

A configuration may be adopted in which in the case where the main work window 6 is closed, the controller 1 does not move any one of the sub-work windows 7 to the main work region F1. As such, in the case where the main work window 6 is closed, the input device 4 may accept a selection as to whether or not to move any one of the sub-work windows 7 to the main work region F1. For example, a user previously makes a setting (a selection) as to this matter on the setting screen of the window display control software 20. In a case where a selection is made to move any one of the sub-work windows 7, when the main work window 6 is closed, the controller 1 moves any one of the sub-work windows 7 to the main work region F1. In a case where a selection is made not to move any one of the sub-work windows 7, even when the main work window 6 is closed, the controller 1 does not move any one of the sub-work windows 7 to the main work region F1.

### Switching between Main Work Window 6 and Sub-Work Window 7

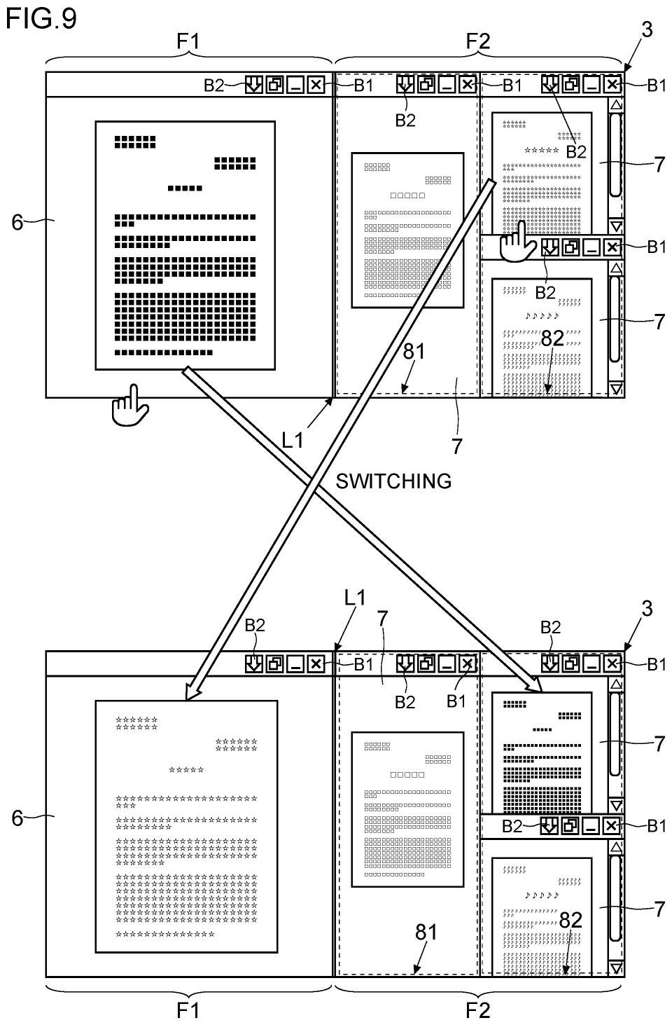

With reference to FIG. 9, a description is given of an example of switching between the main work window 6 and the sub-work window 7 according to the embodiment.

The input device 4 accepts an operation of switching between the main work window 6 and the sub-work window 7. A type of operation used as the switching operation can be appropriately determined. For example, as the switching operation, there can be used an operation of designating the main work window 6 by clicking it while pressing the Ctrl key of the keyboard 41 and then designating the sub-work window 7 by clicking it while pressing the Ctrl key. In the switching operation, double-clicking may be performed instead of clicking. The controller 1 recognizes the main work window 6 and the sub-work window 7, which have been operated (designated).

Upon the switching operation being performed, the controller 1 switches between the main work window 6 operated and the sub-work window 7 operated. FIG. 9 shows an example of switching between the main work window 6 and the sub-work window 7. An upper view in FIG. 9 shows an example in which one main work window 6 is designated as a window to be switched. Furthermore, the upper view in FIG. 9 shows an example in which an upper right one of three sub-work windows 7 is designated as a window to be switched.

A lower view in FIG. 9 shows an example of a state after switching between the main work window 6 and the one of the sub-work windows 7 has been performed. The controller 1 dismisses, from the main work region F1, the main work window 6 designated as a window to be switched. Then, the controller 1 moves the main work window 6 thus dismissed to the sub-work region F2. The controller 1 sets the main work window 6 designated as a window to be switched to be equal in size to the one of the sub-work windows 7 designated as a window to be switched. Furthermore, the controller 1 newly arranges the main work window 6 designated as a window to be switched at the same position as a position of the one of the sub-work windows 7 designated as a window to be switched.

Furthermore, the controller 1 dismisses, from the sub-work region F2, the one of the sub-work windows 7 designated as a window to be switched. Then, the controller 1 moves the one of the sub-work windows 7 thus dismissed to the main work region F1. The controller 1 sets the one of the sub-work windows 7 designated as a window to be switched to be equal in size to the main work window 6 designated as a window to be switched. Furthermore, the controller 1 newly arranges the one of the sub-work windows 7 designated as a window to be switched at the same position as a position of the main work window 6 designated as a window to be switched.

### Synchronizing Window Scrolling

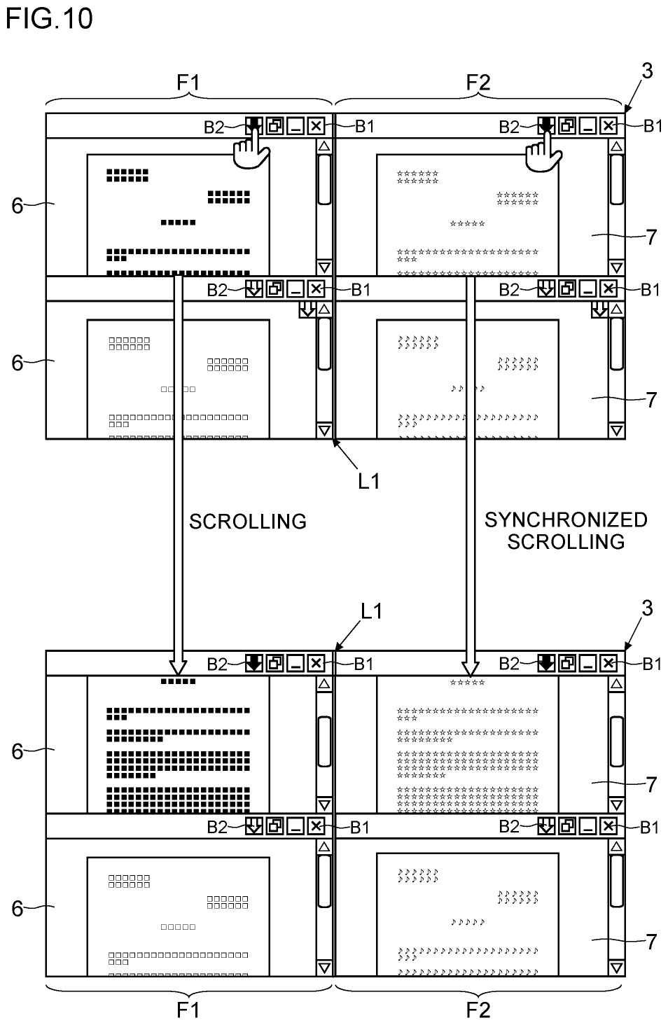

Next, with reference to FIG. 10, a description is given of an example of synchronizing window scrolling according to the embodiment. In each window, contents (a page) can be scrolled. For example, when not all contents of a window are displayed within the window, scrolling can be performed. The input device 4 accepts a scrolling operation. For example, a user uses the mouse 42 to operate a scroll bar provided in a window. The user may operate an arrow key of the keyboard 41. Each of these operations allows contents displayed in a window to be scrolled.

A plurality of windows of the same application may be displayed. For example, a window of the same application as an application of the main work window 6 may be arranged in the sub-work region F2. The controller 1 controls a synchronous scroll button B2 to be included in a bar at an upper edge of each window. In an example shown in FIG. 10, the synchronous scroll button B2 is a quadrangular image including a downward arrow.

By operating the synchronous scroll button B2, it is possible to perform a setting to enable or disable synchronous scrolling. For example, a user clicks the synchronous scroll button B2 with the mouse 42 so as to perform a setting to enable or disable synchronous scrolling. In the example shown in FIG. 10, a state with a hollow arrow indicates a state where synchronous scrolling is disabled. A filled arrow indicates a state where synchronous scrolling is enabled.

Upon scrolling being performed in one window in which synchronous scrolling is enabled, the controller 1 controls scrolling to be performed in the same direction in another window in which synchronous scrolling is enabled, which is of the same application as an application of the one window. Based on a window size ratio, the controller 1 controls scrolling to be performed in the window in which scrolling is to be synchronized.

Specifically, in a case of longitudinal scrolling, the controller 1 recognizes a longitudinal size of each window in which synchronous scrolling is enabled. A longitudinal scrolling amount in a window with respect to which the scrolling operation has been performed is denoted as A1. A longitudinal size of the window with respect to which the scrolling operation has been performed is denoted as W1. A scrolling amount in a window in which scrolling is to be synchronized is denoted as A2. A longitudinal size of the window in which scrolling is to be synchronized is denoted as W2. In this case, A2 is expressed by an equation below.

A2=A1×W2/W1

For example, when W2 is one-half of W1, the controller 1 sets a scroll amount in the window A2 in which scrolling is to be synchronized to be one-half of A1.

FIG. 10 shows an example of synchronous scrolling. An upper view in FIG. 10 shows a state where an operation has been performed to enable synchronous scrolling between an upper main work window 6 and an upper sub-work window 7. A lower view in FIG. 10 shows an example of a state where the controller 1 has performed control so that in synchronization with scrolling in the upper main work window 6, scrolling is performed in the upper sub-work window 7. Upon scrolling of a screen being performed in any one window in which synchronous scrolling is enabled, the controller 1 controls scrolling to be performed in the same direction also in another window in which synchronous scrolling is enabled.

The controller 1 may control synchronous scrolling to be performed between the main work window 6 and the sub-work window 7 only when the sub-work window 7 is of the same application as an application of the main work window 6. The controller 1 may control synchronous scrolling to be performed regardless of whether a window with respect to which the scrolling operation has been performed is the main work window 6 or the sub-work window 7. For example, the controller 1 may perform control so that in synchronization with scrolling in the sub-work window 7, scrolling is automatically performed in another sub-work window 7. Furthermore, the controller 1 may perform control so that in synchronization with scrolling in one main work window 6, scrolling is automatically performed in another main work window 6.

As described above, the information processing apparatus 100 according to the embodiment includes the display 3, the input device 4, and the controller 1. The input device 4 accepts an operation. The controller 1 controls display on the display 3. The controller 1 divides the display region of the display 3 into the main work region F1 and the sub-work region F2. The controller 1 determines whether a window to be newly displayed is to be arranged in the main work region F1 or in the sub-work region F2. When the window is determined to be arranged in the main work region F1, the controller 1 controls the window to be displayed as the main work window 6 within the main work region F1 so that the window does not overlap with any other window. When the window is determined to be arranged in the sub-work region F2, the controller 1 controls the window to be displayed as the sub-work window 7 within the sub-work region F2 so that the window does not overlap with any other window.

Windows can be automatically arranged so as not to overlap with each other. This saves the trouble of adjusting a position and a size of each of windows for the purpose of eliminating overlapping between the windows. Such troublesome adjustment is no longer required. It is, therefore, possible to provide the information processing apparatus 100 that achieves high usability. Furthermore, a window to be newly displayed can be automatically sorted into either the main work region F1 or the sub-work region F2. It is automatically determined whether the window to be newly displayed is to be arranged in the main work region F1 or in the sub-work region F2. The new window can be automatically displayed at an appropriate position. This saves the trouble of performing an operation of changing a position of the window thus newly displayed.

The input device 4 accepts a setting of respective positions and sizes of the main work region F1 and the sub-work region F2 within the display region. The controller 1 controls the main work region F1 and the sub-work region F2 to be displayed on the display 3 so that the respective positions and sizes of the main work region F1 and the sub-work region F2 are as set by the input device 4. Each of the main work region F1 and the sub-work region F2 can be set to have a desired size. Furthermore, each of the main work region F1 and the sub-work region F2 can be set to be at a desired position.

The controller 1 recognizes an application corresponding to a window to be newly displayed. Based on a type of the application thus recognized, the controller 1 determines whether the window to be newly displayed is to be arranged in the main work region F1 or in the sub-work region F2. Depending on a type of an application, it can be determined whether a window to be newly displayed is to be arranged in the main work region F1 or in the sub-work region F2. For example, a window corresponding to an application that is not principally used in operations can be always arranged in the sub-work region F2.

When the number of main work windows 6 arranged has reached the previously determined upper limit value 28, the controller 1 determines to arrange a window to be newly displayed in the sub-work region F2. This makes it possible to limit the number of main work windows 6 arranged. It is possible to prevent the number of main work windows 3 from being excessively increased, resulting in an excessive decrease in size of each of the main work windows 6.

The input device 4 accepts a setting of the upper limit value 28. This makes it possible to set the upper limit value 28 of the number of main work windows 6 arranged. An upper limit of the number of main work windows 6 can be set to a desired value.

When the number of main work windows 6 is one or more after the number of main work windows 6 arranged has been changed, the controller 1 automatically adjusts a size and a position of each of the main work windows 6 so that no unoccupied region is generated in the main work region F1. It is possible to automatically adjust the size of each of the main work windows 6 so that the size is as large as possible and so that the main work windows 6 do not overlap with each other. It is possible to adjust the size and the position of each of the main work windows 6 so as to meet user's satisfaction. This saves a user from having to perform troublesome adjustment.

When automatically adjusting the size and the position of each of the main work windows 6, the controller 1 uniformly divides the main work region F1 by the number of main work windows 6 to be arranged. The controller 1 arranges each of the main work windows 6 in each of regions resulting from the division. The main work windows 6 can be automatically set to be uniform in size.

The input device 4 accepts an operation of closing a window. In a case where the main work window 6 is closed, when there are the sub-work windows 7, the controller 1 moves any one of the sub-work windows 7 to the main work region F1 and dismisses, from the sub-work region F2, the any one of the sub-work windows 7 that has been moved to the main work region F1. When one of the main work windows 6 is closed, one of the sub-work windows 7 can be automatically moved to the main work region F1. A window in the sub-work region F2 can be automatically rearranged in the main work region F1 without requiring an operation for moving the window.

When the number of sub-work windows 7 is one or more after the number of sub-work windows 7 arranged has been changed, the controller 1 automatically adjusts a size and a position of each of the sub-work windows 7 so that the sub-work windows 7 do not overlap with each other. Even when the number of sub-work windows 7 is changed, it is possible to automatically adjust the position of each of the sub-work windows 7 so that they do not overlap with each other. Furthermore, it is possible to automatically adjust the size of each of the sub-work windows 7 so that no useless unoccupied region is generated. It is possible to adjust the size and the position of each of the sub-work windows 7 so as to meet user's satisfaction. This saves a user from having to perform troublesome adjustment.

When controlling a plurality of sub-work windows 7 to be displayed in the sub-work region F2, the controller 1 sets priorities of the plurality of sub-work windows 7. The controller 1 sets one of the plurality of sub-work windows 7 that has a highest priority to be larger in size than the other sub-work windows 7. One of the sub-work windows 7 that has a high priority (level of importance) can be automatically set to be larger in size than the other sub-work windows 7. One of the sub-work windows 7 that has a high priority can be automatically set to have an easily viewable size.

The input device 4 accepts an operation of closing a window. When the main work window 6 is closed in a state where the sub-work windows 7 are displayed, the controller 1 controls one of the sub-work windows 7 that has a highest priority to be displayed in the main work region F1. The controller 1 dismisses, from the sub-work region F2, the one of the sub-work windows 7 that has been moved. When the main work region F1 becomes unoccupied, one of the sub-work windows 7 that has a highest priority can be automatically moved to the main work region F1.

The input device 4 accepts a selection as to whether or not to move the sub-work window 7 when the main work window 6 is closed. In a case where a selection has been made to move the sub-work window 7, the controller 1 moves one of the sub-work windows 7 that has a highest priority to the main work region F1. In a case where a selection has been made not to move the sub-work window 7, even when the main work window 6 is closed, the controller 1 does not move the sub-work window 7 to the main work region F1. It is possible to make a selection as to whether or not to move one of the sub-work windows 7 to the main work region F1. One of the sub-work windows 7 can be automatically moved to the main work region F1 only when so desired. One of the sub-work windows 7 can be prevented from being automatically moved to the main work region F1 when not so desired.

Based on previously determined criteria for determining the priorities, the controller 1 sets the priorities of the sub-work windows 7. The input device 4 accepts a setting of the determination criteria. A user can determine the criteria for determining the priorities of the sub-work windows 7. For example, a window of a specific piece of software (an application) can be set to have a high priority. For example, a window of an application often used by a user can be set to have a high priority.

The input device 4 accepts an operation of switching between the main work window 6 and the sub-work window 7. The controller 1 controls the main work window 6 when subjected to the switching operation to be newly displayed in the sub-work region F2 while dismissing the main work window 6 from the main work region F1. The controller 1 controls the sub-work window 7 when subjected to the switching operation to be newly displayed in the main work region F1 while dismissing the sub-work window 7 from the sub-work region F2. It is possible to easily switch between a desired main work window 6 and a desired sub-work window 7. It is possible to freely and simply switch between the main work window 6 and the sub-work window 7 in accordance with a work situation.

The input device 4 accepts a selection of a plurality of windows in which synchronous scrolling is enabled. Upon scrolling of a screen being performed in any one of the plurality of windows in which the synchronous scrolling is enabled, the controller 1 controls scrolling to be performed in the same direction also in another one of the plurality of windows in which the synchronous scrolling is enabled. Synchronous scrolling can be performed in selected windows. This saves the trouble of individually performing scrolling in each window at the time of correcting or checking a file. There is provided convenience in comparing contents of files.

The foregoing has described the embodiment of the present disclosure. The scope of the present disclosure, however, is not limited thereto. The present disclosure can be implemented by adding various modifications thereto without departing from the spirit of the disclosure.

What is claimed is:

1. An information processing apparatus, comprising:
a display;
an input device that accepts an operation; and
a controller that controls display on the display,
wherein
the controller divides a display region of the display into a main work region and a sub-work region,
the controller determines whether a window to be newly displayed is to be arranged in the main work region or in the sub-work region,
when the window is determined to be arranged in the main work region, the controller controls the window to be displayed as a main work window within the main work region so that the window does not overlap with any other window, and
when the window is determined to be arranged in the sub-work region, the controller controls the window to be displayed as a sub-work window within the sub-work region so that the window does not overlap with any other window.

2. The information processing apparatus according to claim 1, wherein
the input device accepts a setting of respective positions and sizes of the main work region and the sub-work region within the display region, and
the controller controls the main work region and the sub-work region to be displayed on the display so that the respective positions and sizes of the main work region and the sub-work region are as set by the input device.

3. The information processing apparatus according to claim 1, wherein
the controller recognizes an application corresponding to the window to be newly displayed, and
based on a type of the application thus recognized, the controller determines whether the window to be newly displayed is to be arranged in the main work region or in the sub-work region.

4. The information processing apparatus according to claim 1, wherein
based on determination criterion data defining an application to be arranged in the sub-work region, the controller determines whether the window to be newly displayed is to be arranged in the main work region or in the sub-work region, and
the input device accepts editing of the determination criterion data.

5. The information processing apparatus according to claim 1, wherein
when a number of main work windows arranged has reached a previously determined upper limit value, the controller determines to arrange the window to be newly displayed in the sub-work region.

6. The information processing apparatus according to claim 5, wherein
the input device accepts a setting of the upper limit value.

7. The information processing apparatus according to claim 1, wherein
when a number of main work windows is one or more after a number of main work windows arranged has been changed, the controller automatically adjusts a size and a position of each of the main work windows so that no unoccupied region is generated in the main work region.

8. The information processing apparatus according to claim 7, wherein
when automatically adjusting the size and the position of each of the main work windows, the controller uniformly divides the main work region by a number of main work windows to be arranged, and
the controller arranges each of the main work windows in each of regions resulting from dividing the main work region.

9. The information processing apparatus according to claim 1, wherein
the input device accepts an operation of closing the window, and
in a case where the main work window is closed, when there are the plurality of sub-work windows, the controller moves any one of the plurality of sub-work windows to the main work region and dismisses, from the sub-work region, the any one of the plurality of sub-work windows that has been moved to the main work region.

10. The information processing apparatus according to claim 1, wherein
when a number of sub-work windows is one or more after a number of sub-work windows arranged has been changed, the controller automatically adjusts a size and a position of each of the sub-work windows so that the sub-work windows do not overlap with each other.

11. The information processing apparatus according to claim 1, wherein
when controlling a plurality of sub-work windows to be displayed in the sub-work region, the controller sets priorities of the plurality of sub-work windows, and
the controller sets one of the plurality of sub-work windows that has a highest priority to be larger in size than the other sub-work windows.

12. The information processing apparatus according to claim 11, wherein
the input device accepts an operation of closing the window, and
when the main work window is closed, the controller controls the one of the plurality of sub-work windows that has a highest priority to be displayed in the main work region and dismisses, from the sub-work region, the one of the plurality of sub-work windows that has been moved.

13. The information processing apparatus according to claim 12, wherein
the input device accepts a selection as to whether or not to move the sub-work window when the main work window is closed,
in a case where a selection has been made to move the sub-work window, the controller moves the one of the plurality of sub-work windows that has a highest priority to the main work region, and
in a case where a selection has been made not to move the sub-work window, even when the main work window is closed, the controller does not move the sub-work window to the main work region.

14. The information processing apparatus according to claim 11, wherein
based on previously determined criteria for determining the priorities, the controller sets the priorities of the plurality of sub-work windows, and
the input device accepts a setting of the determination criteria.

15. The information processing apparatus according to claim 1, wherein
the input device accepts an operation of switching between the main work window and the sub-work window,
the controller controls the main work window when subjected to the switching operation to be newly displayed in the sub-work region while dismissing the main work window from the main work region, and
the controller controls the sub-work window when subjected to the switching operation to be newly displayed in the main work region while dismissing the sub-work window from the sub-work region.

16. The information processing apparatus according to claim 1, wherein
the input device accepts a selection of a plurality of windows in which synchronous scrolling is enabled, and
upon scrolling of a screen being performed in any one of the plurality of windows in which the synchronous scrolling is enabled, the controller controls the scrolling to be performed in a same direction also in another one of the plurality of windows in which the synchronous scrolling is enabled.

17. A method for controlling an information processing apparatus, comprising steps of:
dividing a display region of a display into a main work region and a sub-work region;
determining whether a window to be newly displayed is to be arranged in the main work region or in the sub-work region;
displaying the window, when the window is determined to be arranged in the main work region, as a main work window within the main work region so that the window does not overlap with any other window; and
displaying the window, when the window is determined to be arranged in the sub-work region, as a sub-work window within the sub-work region so that the window does not overlap with any other window.
